(19) United States
(12) Patent Application Publication
(10) Pub. No.: US 2008/0128050 A1
(43) Pub. Date: Jun. 5, 2008

(54) Pencil Sharpener with Automatic Shut-off

(76) Inventor: Chien Hsin Yeh, Taipei (TW)

Correspondence Address: Richard Chen, 7F., No. 122 Sung Chiang Rd., Taipei, omitted

(21) Appl. No.: 11/566,680

(22) Filed: Dec. 4, 2006

(51) Int. Cl. B43L 23/00; B43L 23/02

(52) U.S. Cl. 144/28.5

(57) ABSTRACT

The invention is related to a pencil sharpener with automatic shut-off, especially at the end of the pencil rail there is a push-pin on a slider, which can slide backward to hit against a tab in the center of the swing rod, so the hooks on the two sides of the swing rod can touch a brake switch after rotation and shut off operation of the power device to stop the sharpening mechanism. Through this, upon completion further inward movement of the pencil allows the pencil tip to press the push-pin and stop the motor, which prevents wastes by excessive sharpening.

### BACKGROUND OF THE INVENTION

1. Field of the Invention

The invention is related to pencil sharpener structure. Specifically, it refers to a pencil sharpener with automatic shut-off function to prevent waste by excessive sharpening.

2. Description of the Prior Art

Traditional pencil sharpener has its main functions in automatic start and stop provided by a hidden device inside a pencil insert hole. When a pencil goes into the hole, it presses the device to start sharpening. Upon completion, the pencil is pulled out and releases the device to stop sharpening. Such an automatic pencil sharpener has been used by the most people for years. However, its largest shortcoming is the inability to know whether sharpening is completed. If the pencil keeps being pushed while sufficient sharpening is already completed, it will create waster by excessive sharpening.

In view of the shortcoming with current automatic pencil sharpener, the inventor sought for solutions and after many tests and experiments finally came up with an innovative, safe, pragmatic and useful pencil sharpener with automatic shut-off device, in the objective to overcome the above shortcoming, improve quality and provide convenience and safety.

### SUMMARY OF THE INVENTION

The main objective for the invention is to provide an innovative pencil sharpener that automatically stops upon completion to prevent waste by excessive sharpening.

To achieve the objective, the pencil sharpener in the invention at least contains a base, a divider, a transmission wheel, a power device, a sharpening mechanism, a cover, a touch switch, an outer case, a panel, a scrap collector etc. Their configuration and function are not very different from traditional pencil sharpener. The pencil sharpener adds new function and mechanism that senses the status of pencil and could automatically shut off. This is carried out as follows: at the end of the pencil rail there is a push-pin on a slider, which can slide backward to hit against a tab in the center of the swing rod, so the hooks on the two sides of the swing rod can touch a brake switch after rotation and shut off operation of the power device to stop the sharpening mechanism. Therefore, upon completion when a pencil is sharpened, further inward movement will allow the pencil to hit the push-pin and stop the motor, which prevents waste by excessive sharpening.

With illustration, description is given to a preferred embodiment for the patent examiners to further understand the invention.

### BRIEF DESCRIPTION OF THE DRAWINGS

FIG. 1 is a structural disassembly diagram for a preferred embodiment for a pencil sharpener in the invention.

FIG. 2 is an exterior diagram for a preferred embodiment for a pencil sharpener in the invention.

FIG. 3 is an illustration for the automatic shut-off for a preferred embodiment for a pencil sharpener in the invention.

### DETAILED DESCRIPTION OF THE PREFERRED EMBODIMENT

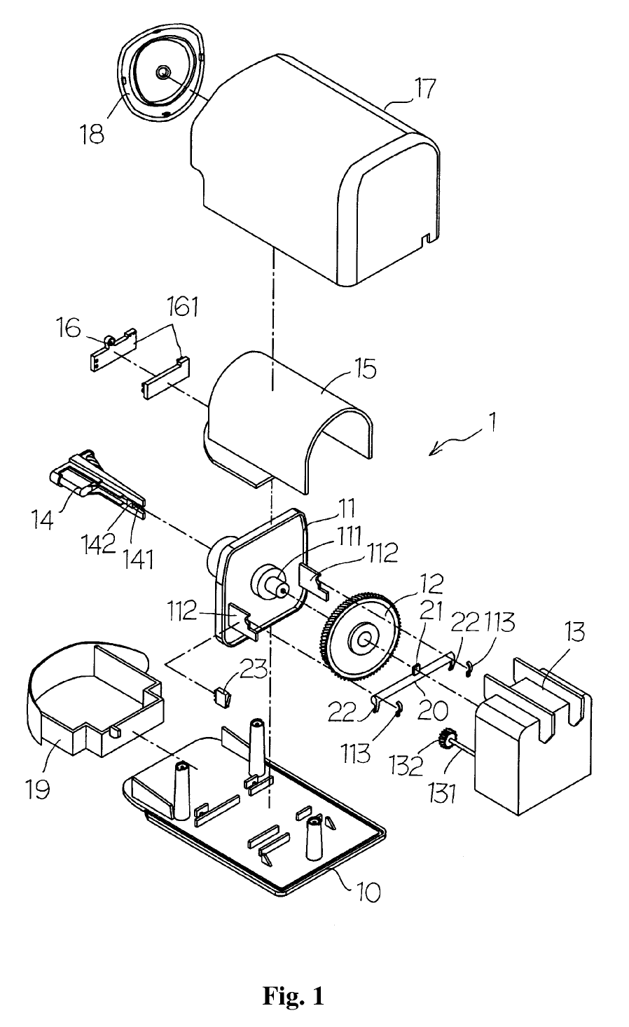

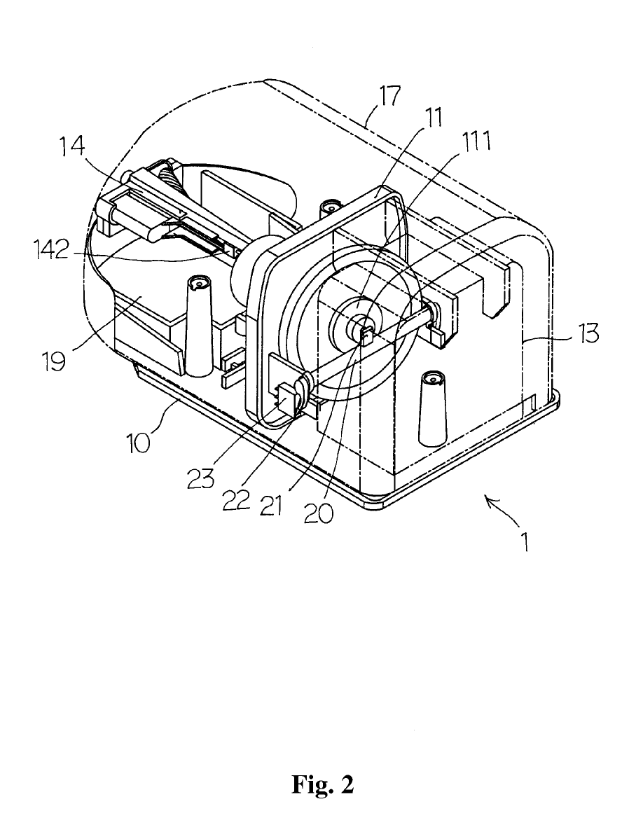

Please refer to FIG. 1 and FIG. 2 for the structural disassembly diagram and exterior diagram for the pencil sharpener with automatic shut-off function in the invention. The pencil sharpener (1) is composed of a base (10), a divider (11), a transmission wheel (12), a power device (13), a sharpening mechanism (14), a cover (15), a touch switch (16), an outer case (17), a panel (18) and a scrap collector (19) etc. The middle of the base (10) has a divider (11) to distinguish the front section and the rear section. The rear section mainly has a transmission wheel (12) and a power device (13). The power device (13) utilizes combination of a transmission axle (131) and a drive gear (132) to drive the transmission wheel (12), and transmits the power to the sharpening mechanism (14) in the front section. The sharpening mechanism (14) is in the front section and connects with the movable part (111) in the center of the divider (11), so it enables power transmission from the power device (13) for sharpening action. Under the sharpening mechanism (14) there is a scrap collector (19) to collect the pencil scraps after sharpening. The sharpening mechanism (14) is covered by a cover (15), which front at the pencil entrance of the sharpening mechanism (14) meets the positioning plate (161) containing hidden touch switch (16), so when the pencil enters, it will press the touch switch (16) to drive the power device (13) and the sharpening mechanism (14). The base (10) has an outer case (17) to cover all the above-mentioned units. It also provides protection and aesthetics. The front of the outer case (17) has a panel (18) with through-hole (181).

The structural characteristics for the invention include: on the two sides of the back part of the divider (11) there are corresponding fixation arms (112) to mount a swing rod (20). A semicircular fixation block (113) is also used for connection and fixation. The swing rod (20) can rotate. In the center of the swing rod (20), there is a tab (21) to fit the through-hole in the center of the movable part (111) in the center of the divider (11). On the opposite sides (far from tab) there are hooks (22). Outside the two fixation arms (112) there is a brake switch (23). At the rear end of the sharpening mechanism (14) there is a push-pin (141) on a slider (142), which can slide and allow the push-pint to pass through the through-hole in the center of the movable part (111) to press the tab (21). As the push-pin (141) moves backwards to press the tab (21) and rotates the swing rod (20), the hooks (22) on the two sides can touch the brake switch (23) to immediately shut off the power transmission of the power device (13).

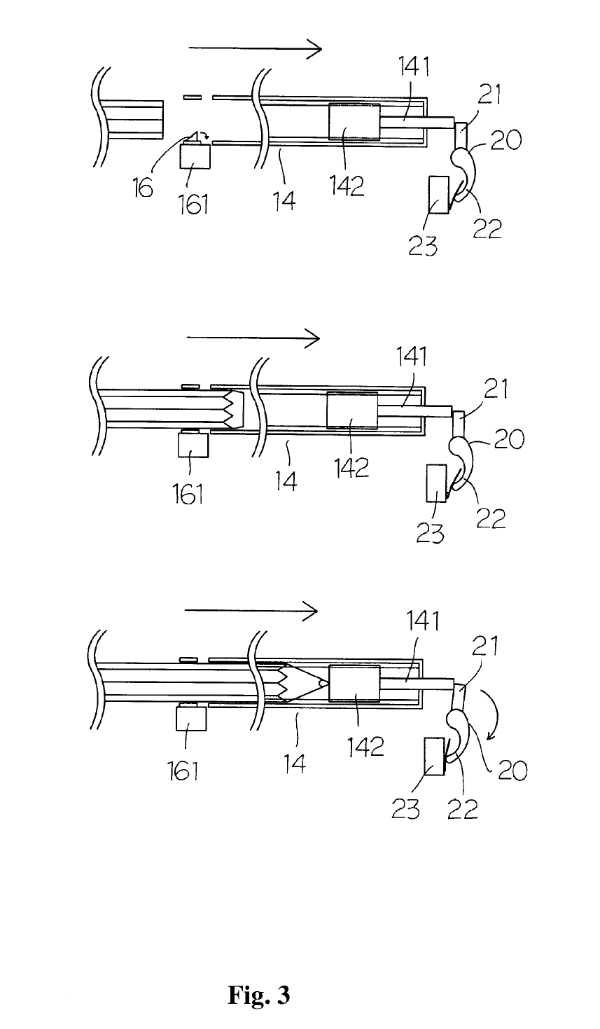

Please refer to FIG. 3 for a preferred embodiment for the pencil sharpener with automatic shut-off. The pencil enters the hole in the center of the panel (18) in the front of the outer case (17), then presses the hidden touch switch (16) inside the hole on the positioning plate (161), and activates the operation of power device (13), and transmits the power to the sharpening mechanism (14). Inward movement of the pencil enables the sharpening by the sharpening mechanism (14). In the process, the scraps will fall into the scrap collector (19). Further inward movement of already sharpened pencil allows the pencil tip to press the slider (142) and the push-pin (141) backward. When the push-pin (141) is pushing the tab (21) and rotates the swing rod (20), it also makes the hooks (22) on the two sides to touch the brake switch (23), and immediately shuts off the power transmission of the power device (13) and stops the operation of the sharpening mechanism (14). This will prevent wastes by excessive sharpening.

From the above description, it is known that the invention obtains the pencil status upon completion through sensing device in the pencil sharpener and can cut power transmission and stop sharpening. Such a structure with automatic shut-off function is convenient and practical, with significant commercial value

What is claimed is:

1. A pencil sharpener with automatic shut-off is composed of a base, a divider, a transmission wheel, a power device, a sharpening mechanism, a cover, a touch switch, an outer case, a panel, a scrap collector; in the middle of the base, there are dividers to separate front section and rear section; the rear section has a transmission wheel and a power device; the sharpening mechanism is located in the front section and connects to the movable part in the center of the divider; under the sharpening mechanism is a scrap collector; above is a cover; the front has a positioning plate with a hidden touch switch; the front end of the base has an outer case and a panel with a through-hole with features in:
on the two sides of the back of the divider there are corresponding fixation arms to mount a swing rod; a semicircular fixation block is used for combination and fixation and allows rotation of the swing rod; in the center of the swing rod there is a tab to fit the through-hole in the center of the movable part in the center of divider; on the opposite sides (far from tab) there are hooks; outside the two fixation arms, there is a brake switch; at the end of the sharpening mechanism, there is a push-pin on a slider, which can slide backward through the through-hole in the center of the movable part to hit against a tab in the center of the swing rod, so the hooks on the two sides of the swing rod can touch a brake switch after rotation and shut off operation of the power device to stop the sharpening mechanism.

2. As described in claim 1 for a pencil sharpener with automatic shut-off, the power device uses combination of a transmission axle and a drive gear and transmission wheel to transmit power to the front sharpening mechanism.
